(19) United States
(12) Patent Application Publication
(10) Pub. No.: US 2009/0109409 A1
(43) Pub. Date: Apr. 30, 2009

(54) LIGHTING UNIT AND PROJECTION DISPLAY APPARATUS

(75) Inventors: Masahiro HARAGUCHI, Daito (JP); Susumu TANASE, Kadoma (JP); Yoshinao HIRANUMA, Hirakata (JP); Tomoya TERAUCHI, Daito (JP); Takaaki ABE, Osaka (JP); Masutaka INOUE, Hirakata (JP)

Correspondence Address: MOTS LAW, PLLC, 1629 K STREET N.W., SUITE 602, WASHINGTON, DC, 20006-1635, US

(73) Assignee: SANYO ELECTRIC CO., LTD., Moriguchi (JP)

(21) Appl. No.: 12/256,607

(22) Filed: Oct. 23, 2008

(30) Foreign Application Priority Data
Oct. 24, 2007 (JP) 2007-276774

(51) Int. Cl. G03B 21/20; G01J 1/32

(52) U.S. Cl. 353/85; 250/205

(57) ABSTRACT

A projection display apparatus 100 including a plurality of solid state light sources 11 includes: a sensor 70 detecting an amount of light emitted from the plurality of solid state light sources 11; a degradation rate calculating unit 250 acquiring, from the amount of light detected by the sensor 70, an amount of light emitted from a measurement target light source which is any one of the plurality of solid state light sources: and a light source controlling unit 240 controlling, for each of the plurality of state light sources 11, emission periods in which the plurality of solid state light sources 11 emit light so that the degradation rate calculating unit 250 acquires the amount of light emitted from the measurement target light

### BACKGROUND OF THE INVENTION

1. Field of the Invention

The present invention relates to a lighting unit provided with a plurality of solid state light sources, and a projection display apparatus.

2. Description of the Related Art

A projection display apparatus has heretofore been known, which is provided with a light imager (a liquid crystal panel or the like) for modulating light emitted from a light source. The projection display apparatus projects, on a screen, the light modulated by the light imager. In addition, an attempt has been made to employ a solid state light source such as a laser diode or an LED, for a light source provided to a projection display apparatus.

However, only a single solid state light source does not secure a required amount of light for a projection display apparatus. Therefore, a plurality of solid state light sources have generally been provided to a projection display apparatus.

Meanwhile, solid state light sources are degraded in some cases due to change of ambient temperature of the solid state light sources. Additionally, solid state light sources also degrade with time in some cases. Because of such degradation of solid state light sources, a total amount of light emitted from the plurality of solid state light sources may not sum into a desired amount of light Accordingly, the degradation of each of the plurality of state light source needs to be detected.

A projection display apparatus provided with a sensor for detecting a state of a light source has heretofore been proposed. It is disclosed (e.g., Patent Document 1.) that when a plurality of light sources are provided to the projection display apparatus, a plurality of sensors are provided so as to correspond respectively to the plurality of light sources.

(Patent Document 1, Japanese Patent Application Publication No. Hei 9-200662, claims 1 and 2, for example)

In the above-described projection display apparatus, a plurality of sensors corresponding respectively to a plurality of light sources are provided. Accordingly, the number of sensors increases as the number of light sources increases, so that the production cost of a projection display apparatus increases. In addition, as the number of sensors increases, the control on each sensor becomes more complicated.

In addition, the provision of a plurality of solid state light sources to the projection display apparatus causes the following problem. Specifically, even when a plurality of sensors corresponding respectively to the plurality of solid state light sources are provided, the exact detection of only the light emitted from each of the solid state light sources is difficult.

### SUMMARY OF THE INVENTION

An aspect of a lighting unit includes a plurality of solid state light sources (solid state light sources 11). The lighting unit includes; a sensor (light amount sensor 70) detecting an amount of light emitted from the plurality of solid state light sources, a light source controlling unit (source controlling unit 240) controlling, for each of the plurality of state light sources, emission periods in which the plurality of solid state light sources emit light, and an acquisition unit (degradation rate calculating unit 250) acquiring, from the amount of light detected by the sensor, an amount of light emitted from a measurement target light source which is any one of the plurality of solid state light sources. The light source controlling unit controls the emission periods so that the acquisition unit acquires the amount of light emitted from the measurement target light source.

In the above aspect, the light source controlling unit controls, for each of the plurality of state light sources, the emission periods in which the plurality of solid state light sources emit light so that the acquisition unit acquires the light amount emitted from the measurement target light source. Therefore, it becomes possible to detect the amount of light emitted from each of the plurality of solid state light sources when the plurality of solid state light sources are provided to the projection display apparatus.

According to the above aspect, the lighting unit further includes a calculating unit (light source controlling unit 240) calculating a required amount of light for one frame section based on an image input signal corresponding to the one frame section. The light source controlling unit controls the emission periods in the one frame section based on the required amount of light calculated by the calculating unit

According to the above aspect, The light source controlling unit controls, in a predetermined frame section, a ratio between the emission periods and non-emission periods, the non-emission periods is periods which the plurality of solid state light sources emit no light

According to the above aspect. The light source controlling unit outputs, in a predetermine cycle, to each of the plurality of state light sources, a control signal controlling the amount light emitted from the plurality of solid state light sources. It should be noted that an amount of light controlled by the control signal is output power from each of the plurality of state light resources, and the amount of light does not include a concept of time axial direction.

According to the above aspect, the light source controlling unit controls the emission periods so that the acquisition unit consecutively acquires the amount of light emitted from the measurement target light source.

According to the above aspect, the lighting unit includes a temperature sensor to detect temperatures of the plurality of solid state light sources, and an acquired result by the acquisition unit is corrected in accordance with a detected result by the temperature sensor.

According to the above aspect, the acquisition unit acquires the amount of light emitted from the measurement target light source which is the any one of the plurality of solid state light sources only when a predetermined measurement instruction signal is given.

According to the above aspect, The lighting unit includes; a memory unit (correspondence relation memory unit 230) storing, for each of the plurality of state light sources, a correspondence relation between power supplied to each of the plurality of solid state light sources and the amount of light emitted from each of the plurality of solid state light sources, and an updating unit (degradation rate calculating unit 250) updating, for each of the plurality of state light sources, the correspondence relation in accordance with the amount of light emitted from the measurement target light source acquired by the acquisition unit. The light source controlling unit increases power supplied to a solid state light source having high light emission efficiency among the plurality of solid state light sources with reference to the memory unit, when increasing a total amount of light emitted from the plurality of solid state light sources.

According to the above aspect. The lighting unit includes; a memory unit (correspondence relation memory unit 230) storing, for each of the plurality of state light sources, a correspondence relation between power supplied to each of the plurality of solid state light sources and the amount of light emitted from each of the plurality of solid state light sources, and an updating unit (degradation rate calculating unit 250) updating, for each of the plurality of state light sources, the correspondence relation in accordance with the amount of light emitted from the measurement target light source acquired by the acquisition unit The light source controlling unit reduces power supplied to a solid state light source having low light emission efficiency among the plurality of solid state light sources with reference to the memory unit, when reducing the total amount of light emitted from the plurality of solid state light sources.

An aspect of a projection display apparatus includes the lighting unit having at least one of the above features and a projection lens unit for projecting light emitted from the lighting unit.

### BRIEF DESCRIPTION OF THE DRAWINGS

FIG. 1 is a schematic view showing a configuration of a projection display apparatus 100 according to a first embodiment.

FIG. 2 is a block diagram showing a configuration of a controlling unit 200 according to the first embodiment.

FIG. 3 is a view showing an example of information stored in a correspondence relation memory unit 230 according to the first embodiment.

FIG. 4 is a view for explaining an example 1 of controlling a light source according to the first embodiment.

FIG. 5 is a view for explaining an example 2 of controlling a light source according to the first embodiment.

FIG. 6 is a view for explaining an example 3 of controlling a light source according to the first embodiment.

FIG. 7 is a view for explaining an example 4 of controlling a light source according to the first embodiment.

FIG. 8 is a view for explaining an example 5 of controlling a light source according to the first embodiment.

FIG. 9 is a view for explaining an example 6 of controlling a light source according to the first embodiment.

FIG. 10 is a view showing a stable period of an amount of light emitted from a plurality of solid state light sources 11 according to the first embodiment, in emission and non-emission.

FIG. 11 is a view for explaining an example 7 of controlling a light source according to the first embodiment.

FIG. 12-1 is a view showing a control method according to a modification 1 according to the first embodiment.

FIG. 12-2 is a view showing the control method according to the modification 1 according to the first embodiment.

FIG. 13 is a block diagram showing a configuration of a controlling unit 200 according to a modification 2 according to the first embodiment.

FIG. 14 is a view showing a temperature correction method according to the modification 2 according to the first embodiment.

FIG. 15 is a view showing a change, with respect to time, in an amount of light of all the plurality of solid state light sources 11 according to a modification 4 according to the first embodiment.

FIG. 16 is a flowchart showing operation of the projection display apparatus 100 according to the first embodiment.

FIG. 17 is a flowchart showing operation of the projection display apparatus 100 according to the first embodiments.

FIG. 18 is a schematic view showing a configuration of a projection display apparatus 100 according to a second embodiment.

### DETAILED DESCRIPTION OF THE PREFERRED EMBODIMENTS

A projection display apparatus according to an embodiment of the present invention is described below with reference to the accompanying drawings. In the following drawings, same or similar parts are denoted with same or similar reference numerals.

It should be noted that the drawings are only schematic so that dimensional ratios or the like are not equal to the actual ones. Accordingly, the specific sizes or the like should be determined by referring to the descriptions to be provided below.

### First Embodiment

### (Configuration of a Projection Display Apparatus)

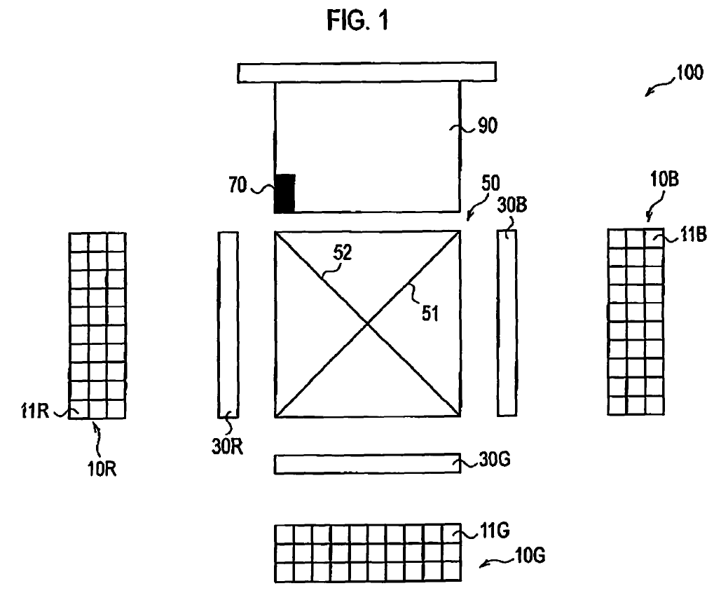

The configuration of a projection display apparatus according to a first embodiment of the present invention is described below with reference to drawings. FIG. 1 is a schematic view showing a configuration of a projection display apparatus 100 according to the first embodiment

As shown in FIG. 1, the projection display apparatus 100 includes a plurality of array light sources 10 (array light sources 10R, 10G and 10B) in which a plurality of solid state light sources 11 (solid state light sources 11R, 11G, and 11B) are arranged in array; a plurality of light imagers 30 (light imagers 30R, 30G, and 30B); a cross dichroio prism 50; and a projection lens unit 90 provided with a light amount sensor 70.

It should be noted that in FIG. 1, an optical element (e.g., a tapered rod or a fly eye lens) for uniformizing light emitted from the array light sources 10, and the like are omitted for a clear description.

The array light sources 10, the light imagers 30, the cross dichroic prism 50, and the light amount sensor 70 constitute a lighting unit.

In the array light source 10R, a plurality of solid state light sources 11R emitting red component light are arranged in array. The solid state light source 11R is a solid state light source such as a red LED or LD.

Similarly, in the array light source 10G, a plurality of solid state light sources 11G emitting green component light are arranged in array. The solid state light source 11G is a solid state light source such as a green LED or LD. In addition, in the array light source 10B, a plurality of solid state light sources 11B emitting blue component light are arranged in array. The solid state light source 11B is a solid state light source such as a blue LED or LD.

Meanwhile, the arrangement form of the solid state light sources 11 in the array light sources 10 are not limited to a square shape. For example, the arrangement form of the solid state light sources 11 in the array light sources 10 may be an X, a cross, a circular, or any other shape.

The light imager 30R is an optical element (e.g., a transmissive liquid crystal panel) which modulates red component light emitted from the array light source 10R.

Similarly, the light imager 30G is an optical element (e.g., a transmissive liquid crystal panel) which modulates green component light emitted from the array light source 10G. In addition, the light imager 30B is an optical element (e.g., a transmissive liquid crystal panel) which modulates blue component light emitted from the array light source 10B.

However, the light imager 30 is not limited to a transmissive liquid crystal panel. For example, the light imager 30 may be a reflective liquid crystal panel or a digital micromirror device (DMD).

The cross dichroic prism 50 is a color combining unit which combines each of color component lights emitted from the light imagers 30R, 30G, and 30B. Specifically, the cross dichroic prism 50 includes a dichroic film 51 which reflects red component light emitted from the light imager 30R and transmits green component light emitted from the light imager 30G, and a dichroic film 52 which reflects blue component light emitted from the light imager 30B and transmits green component light emitted from the light imager 30G.

A combined light combined by the cross dichroio prism 50 is led to a projection lens unit 90 to which the light amount sensor 70 is provided.

The light amount sensor 70 is provided on a path of the synthetic light combined by the cross dichroic prism 50. The light amount sensor 70 detects an amount of the synthetic light combined by the cross dichroic prism 50. The light amount sensor 70 may be arranged in any position which allows the light amount sensor 70 to detect the synthetic light combined by the cross dichroic prism 50.

Incidentally, the light amount sensor 70 is preferably provided outside an effective use range of the synthetic light combined by the cross dichroic prism 50. The effective use range is a range of synthetic light which is used for an image projected by the projection lens unit 90. Accordingly, the outside the effective use range is a portion (what is termed as overscan portion) which is not used for an image to be projected by the projection lens unit 90.

The projection lens unit 90 projects, on a screen (not shown), the synthetic light combined by the cross dichroic prism 50. Thus, an image is displayed on the screen.

### (Configuration of a Control Unit)

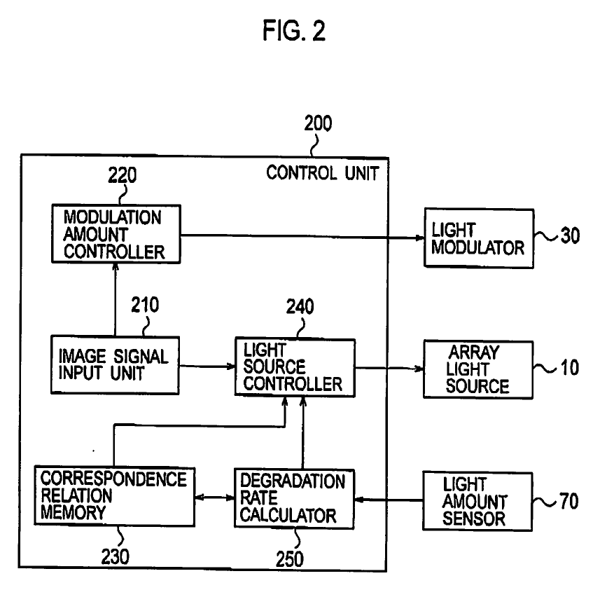

A configuration of a controlling unit according to the first embodiment is described below with reference to drawings. FIG. 2 is a block diagram showing a configuration of a controlling unit 200 according to the first embodiment.

As shown in FIG. 2, the controlling unit 200 includes an image signal input unit 210, a modulation amount controlling unit 220, a correspondence relation memory unit 230, a light source controlling unit 240, and a degradation rate calculating unit 250.

The image signal input unit 210 acquires an image input signal including a red input signal R, a green input signal G, and a blue input signal B from an external device (e.g., a personal computer, a DVD reproducer, a TV tuner, or the like). The image signal input unit 210 inputs the image input signal into the modulation amount controlling unit 220 and the light source controlling unit 240.

In response to the image input signal acquired from the image signal input unit 210, the modulation amount controlling unit 22D controls the light imagers 30 (light imagers 30R, 30G, and 30B).

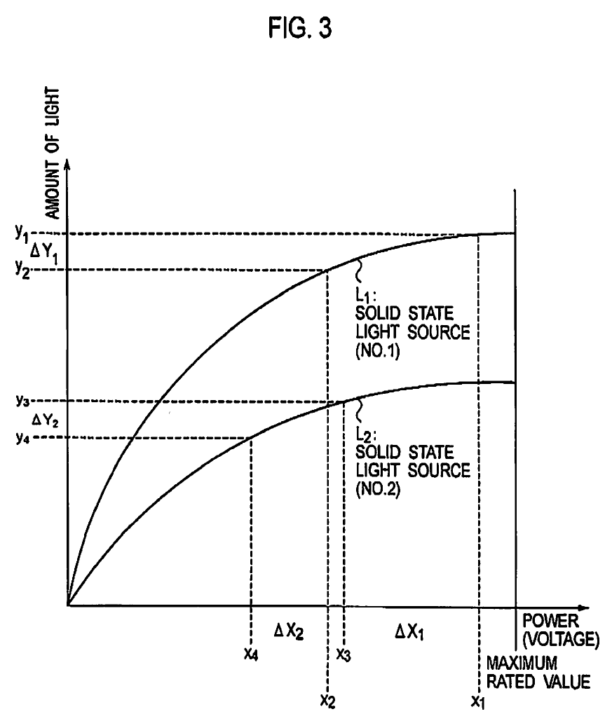

As shown in FIG. 3, the correspondence relation memory unit 230 stores, for each of the plurality of state light sources 11, a correspondence relation between power supplied to a solid state light source 11 and an amount of light emitted from the solid state light source 11. An initial value of the correspondence relation is a value measured at an initial stage before degradation or the like of the solid state light source 11 has occurred, a rated value determined to the solid state light source 11, or the like.

The light source controlling unit 240 controls, for each of the plurality of state light sources 11, emission periods in which the plurality of solid state light sources 11 emit light More specifically, the light source controlling unit 240 controls the light emission period so that the degradation rate calculating unit 250 to be described later acquires an amount of light of a measurement target light source which corresponds to any one of the plurality of solid state light sources 11.

Here, based on an image input signal corresponding to one frame section, the light source controlling unit 240 calculates a required amount of light for the one frame section. Subsequently, the light source controlling unit 240 controls the light emission period of each of the plurality of solid state light sources 11 so that a total amount of light emitted from the plurality of solid state light sources 11 satisfies the required amount of light.

Incidentally, in FIG. 3, a solid state light source 11 of a light source No. 1 and a solid state light source 11 of a light source No. 2 are cited as examples of the solid state light sources 11.

The reason why a curve L₂ showing a correspondence relation on the solid state light source 11 of the light source No. 2 is different from a curve L₁ showing a correspondence relation on the solid state light source 11 of the light source No. 1 is because the solid state light source 11 of the light source No. 2 has the time degradation, or the like.

Here, consideration is made to light emission efficiency on the solid state light source 11 of the light source No. 1 and the solid state light source 11 of the light source No. 2. The light emission efficiency is an increment of an amount of light with respect to an increment of power. In other words, the larger the increment of the amount of light with respect to the increment of power, the higher the light emission efficiency. Meanwhile, the light emission efficiency is also considered as a decrement of an amount of light with respect to a decrement of power. In other words, the smaller the decrement of an amount of light with respect to the decrement of power, the lower the light emission efficiency.

When the levels of the power are assumed to be the same, the light emission efficiency of the solid state light source 11 of the light source No. 1 is basically higher than that of the light source No. 2. The light emission efficiencies of the solid state light sources 11 of the light sources No. 1 and No. 2 reduce as the power approaches a maximum rated value.

Meanwhile, consideration is made on a case where power supplied to the solid state light source 11 of the light source No. 1 is x₂ while the power supplied to the solid state light source 11 of the light source No. 2 is x₄. An amount of light emitted from the solid state light source 11 of the light source No. 1 is y₂ while that emitted from the solid state light source 11 of the light source No. 2 is y₄.

When increasing the amount of light by ΔY₁(y₁−y₂), power to be supplied to the solid state light source 11 of the light source No. 1 needs to be increased by ΔX₁(x₁−x₂). Similarly, when increasing the amount of light by ΔY₂(y₃−y₄), power to be supplied to the solid state light source 11 of the light source No. 2 needs to be increased by ΔX₂(x₃−x₄). Incidentally. ΔY₁ equals to ΔY₂, and ΔX₁ is larger than ΔX₂. In other words, the light emission efficiency of the solid state light source 11 of the light source No. 2 is higher than that of No. 1.

As described above, it should be noted that the light emission efficiency of the solid state light source 11 is subject to change depending on power currently supplied to the solid state light source 11.

In addition, in the case where power supplied to the solid state light source 11 of the light source No. 1 is x₂ and that supplied to the solid state light source 11 of the light source No. 2 is x₄, when increasing the amount of light by ΔY(=ΔY₁=ΔY₂), it is more advantageous to increase power to be supplied to the solid state light source 11 of the light source No. 2 having higher light emission efficiency. Specifically, an increase in the power consumption of the plurality of solid state light sources 11 can be prevented.

In the meantime, in the case where power supplied to the solid state light source 11 of the light source No. 1 is x₁ and that supplied to the solid state light source 11 of the light source No. 2 is x₃, when decreasing the amount of light by ΔY (=ΔY₁=ΔY₂), it is more advantageous to reduce power supplied to the solid state light source 11 of the light source No. 1 having lower light emission efficiency. Specifically, an increase in the power consumption of the plurality of solid state light sources 11 can be prevented.

For a method of controlling the light emission period, for example, following light source control examples are considered.

### (Light Source Control Example 1)

In a light source control example 1, a period in which only a measurement target light source corresponding to any one of the plurality of solid state light sources 11 emits light is provided in one frame section. Specifically, the light source controlling unit 240 does not cause the solid state light sources 11 other than the measurement target light source to emit light during a period in which a measurement target light source emits light.

In the light source control example 1, the light source controlling unit 240 controls a ratio (duty) between a period (a light emission period) for which a solid state light source 11 emits light and a period (a non-light emission period) for which solid state light sources 11 emits no light More specifically, the light source controlling unit 240 controls the ratio (duty) in one frame section (a predetermined period).

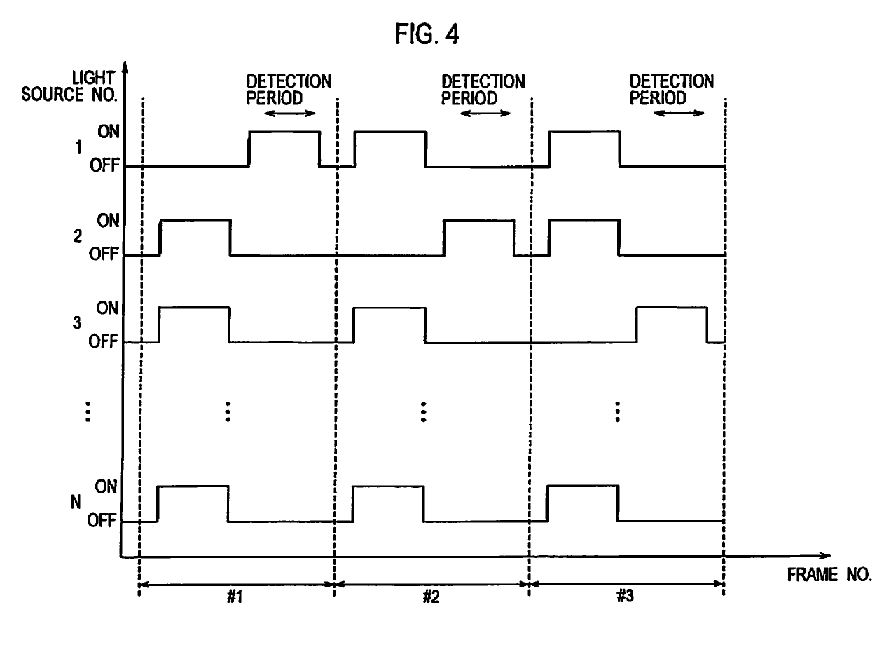

For example, as shown in FIG. 4, in a frame #1, during a period (a light emission period) for which a solid state light source 11 (i.e., a measurement target light source) of the light source No. 1 emits light, the solid state light sources 11 of light sources No. 2 to No. N emit no light.

Similarly, in a frame #2, during a period (a light emission period) for which a solid state light source 11 (i.e., a measurement target light source) of the light source No. 2 emits light, the solid state light sources 11 of the light source No. 1 and light sources No. 3 to No. N emit no light. The same holds for a frame #3 onward.

Thus, only an amount of light emitted from a measurement target light source is detected during a period (a detection period) for which the light amount sensor 70 detects light.

Here, in the light source control example 1, since only a phase of the light emission period of the measurement target light source is shifted, it is easy to maintain an amount of light emitted from the plurality of solid state light sources 11 so that an amount of light in one frame section satisfies a desired amount of light.

### (Light Source Control Example 2)

In a light source control example 2, as in the light source control example 1, a period in which only a measurement target light source corresponding to any one of the plurality of solid state light sources 11 emits light is provided in one frame section. The light source controlling unit 240 controls the ratio (duty) in one frame section (a predetermined period).

However, in the light source control example 2, the case is assumed where a required amount of light is larger than that in the light source control example 1. Accordingly, a light emission period of the measurement target light source is larger than that of the light source control example 1 and spans the one frame section. In other words, even during periods for which solid state light sources 11 other than the measurement target light source emit light, the measurement target light source emits light.

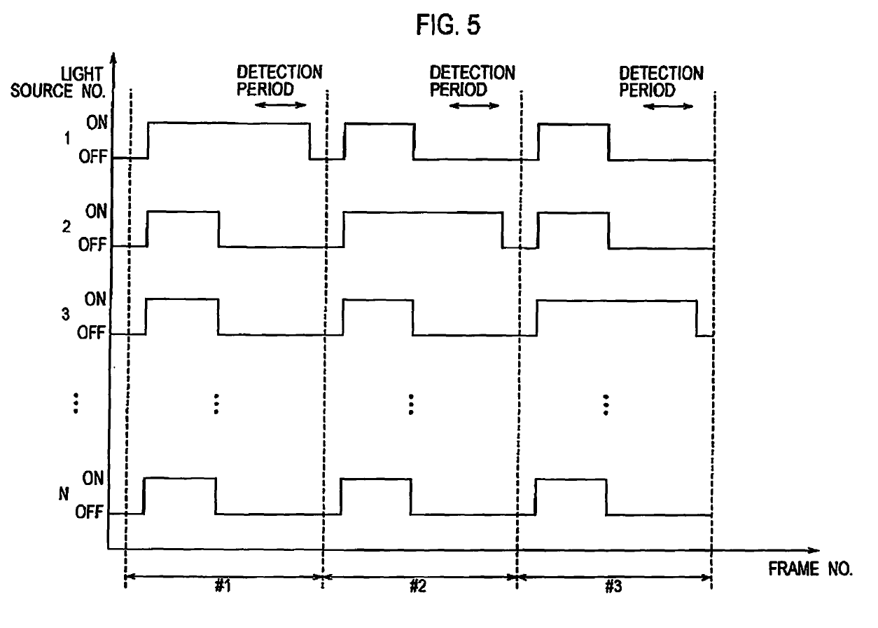

For example, as shown in FIG. 5, in a frame #1, during a period (a light emission period) for which a solid state light source 11 (i.e., a measurement target light source) of the light source No. 1 emits light, the solid state light sources 11 of light sources No. 2 to No. N emit no light. However, the solid state light source 11 of the light source No. 1 emits light over one frame section.

Similarly, in a frame #2, during a period (a light emission period) for which a solid state light source 11 (i.e., a measurement target light source) of the light source No. 2 emits light, the solid state light sources 11 of the light source No. 1 and light sources No. 3 to No. N emit no light However, the solid state light source 11 of the light source No. 2 emits light over one frame section.

Thus, during a period (a detection period) for which the light amount sensor 70 detects light only an amount of light emitted from a measurement target light source is detected.

### (Light Source Control Example 3)

In a light source control example 3. as in the light source control example 1, a period in which only a measurement target light source corresponding to any one of the plurality of solid state light sources 11 emits light is provided in one frame section. The light source controlling unit 240 controls the ratio (duty) in one frame section (a predetermined period).

However, in the light source control example 3, the case is assumed where a required amount of light is extremely large in a specific frame section. Accordingly, the light amount detection using the light amount sensor 70 is skipped over the specific frame section.

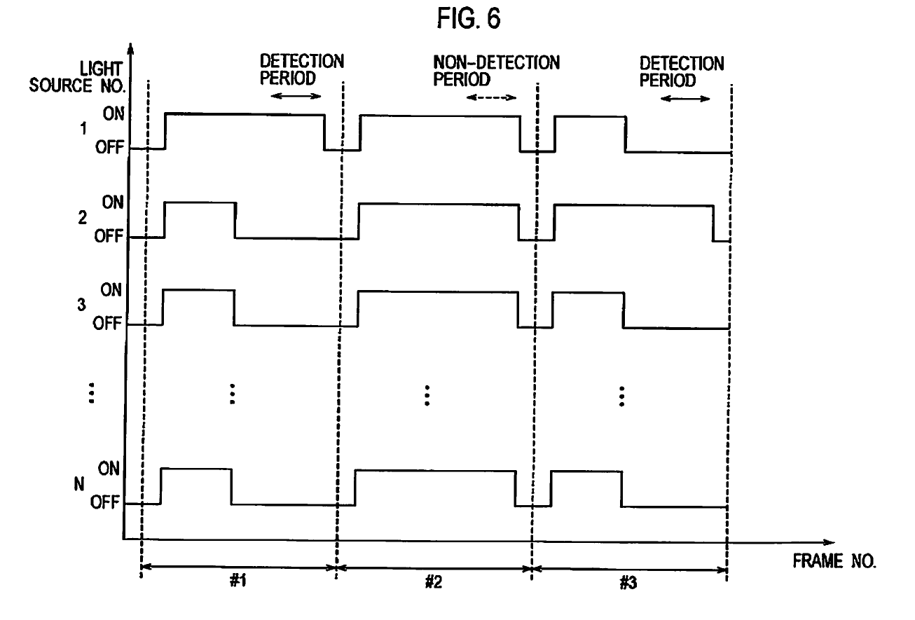

For example, as shown in FIG. 6, in a frame #1, during a period (a light emission period) for which a solid state light source 11 (i.e., a measurement target light source) of the light source No. 1 emits light, the solid state light sources 11 of light sources No. 2 to No. N emit no light.

Meanwhile, in the frame #2 (i.e., in the specific frame section), since a required amount of light calculated on the basis of an image input signal is extremely large, the emission periods of all the solid state light sources 11 span the one frame section. Accordingly, the light amount detection by the light amount sensor 70 is skipped in the frame #2.

In the frame #3, during a period (a light emission period) for which the solid state light source 11 of the light source No. 2 (that is the measurement target light source) emits light, the solid state light sources 11 of the light source No. 1 and light sources No. 3 to No. N emit no light.

As described above, after skipping the light amount detection by the light amount sensor 70, an amount of light emitted from the subsequent measurement target light source is detected so that amounts of light emitted from all the solid state light sources 11 are sequentially detected.

### (Light Source Control Example 4)

In a light source control example 4, as in the light source control example 1, the light source controlling unit 240 controls the ratio (duty) in one frame section (a predetermined period).

However, in the light source control example 4, the case is assumed where a required amount of light is larger than that in the light source control example 1. Accordingly, the light emission period of a measurement target light source is larger than that of the light source control example 1 and spans one frame section. In addition, in a specific frame section, at least two solid state light sources 11 emit light over one frame section.

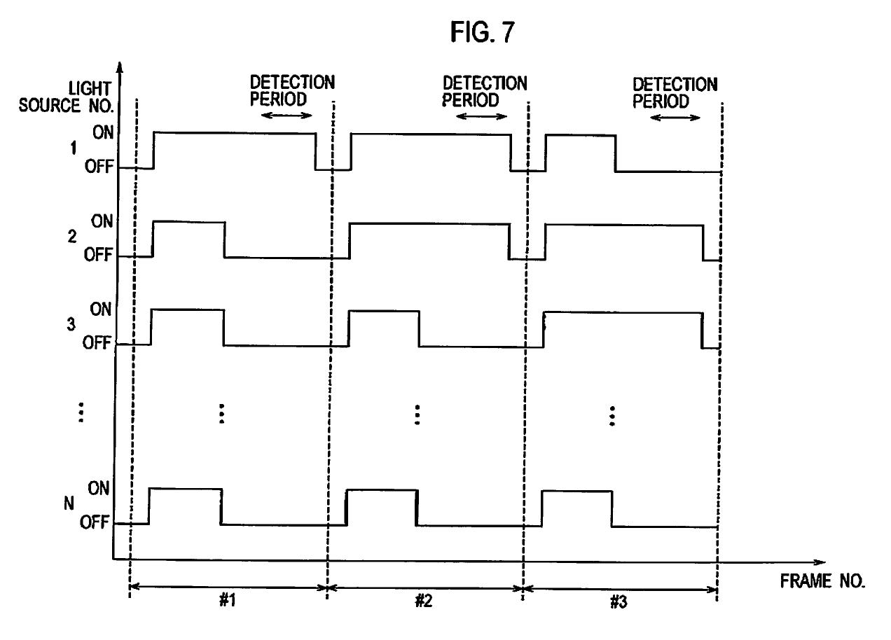

For example, as shown in FIG. 7, in a frame #1, during a period (a light emission period) for which a solid state light source 11 (i.e., a measurement target light source) of the light source No. 1 emits light, the solid state light sources 11 of light sources No. 2 to No. N emit no light. However, the solid state light source 11 of the light source No. 1 emits light over one frame section.

In the frame #2, during a period (a light emission period) for which the solid state light sources 11 of the light sources No. 1 and No. 2 emit light, the solid state light sources 11 of the light sources No. 3 to No. N emit no light. However, the solid state light sources 11 of the light sources No. 1 and No. 2 emit light over one frame section.

Here, in the frame #1, an amount of light emitted from the solid state light source 11 of the light source No. 1 has already been detected. Therefore, a difference between an amount of light measured in the frame #2 and that measured in the frame #1 corresponds to an amount of light emitted from the solid state light source 11 of the light source No. 2. In other words, in the frame #2, the solid state light source 11 of the light source No. 2 is the measurement target light source.

As described above, with the use of a difference between the amount of light detected using the light amount sensor 70 and the already detected amount of light emitted from the solid state light source 11, only an amount of light emitted from the measurement target light source is acquirable.

Incidentally, in FIG. 7, in the frame #3, the solid state light sources 11 of the light sources No. 2 and No. 3 emit light over one frame section. However, the solid state light sources 11 are not limited thereto. Specifically, since the amounts of light emitted from the solid state light sources 11 of the light sources No. 1 and No. 2 have already been detected, the solid state light sources 11 of the light sources No. 1 to No. 3 may emit light over one frame section.

### (Light Source Control Example 5)

In a light source control example 5, as in the light source control example 1, the light source controlling unit 240 controls the ratio (duty) in one frame section (a predetermined period).

However, in the light source control example 5, the case is assumed where a detection accuracy of the light amount sensor 70 is poorer than that of the light source control example 1. More specifically, in the light source control example 5, a detection period is longer than that of the light source control example 1. Accordingly, the detection period is longer than a period (a light emission period) for which only a measurement target light source emits light.

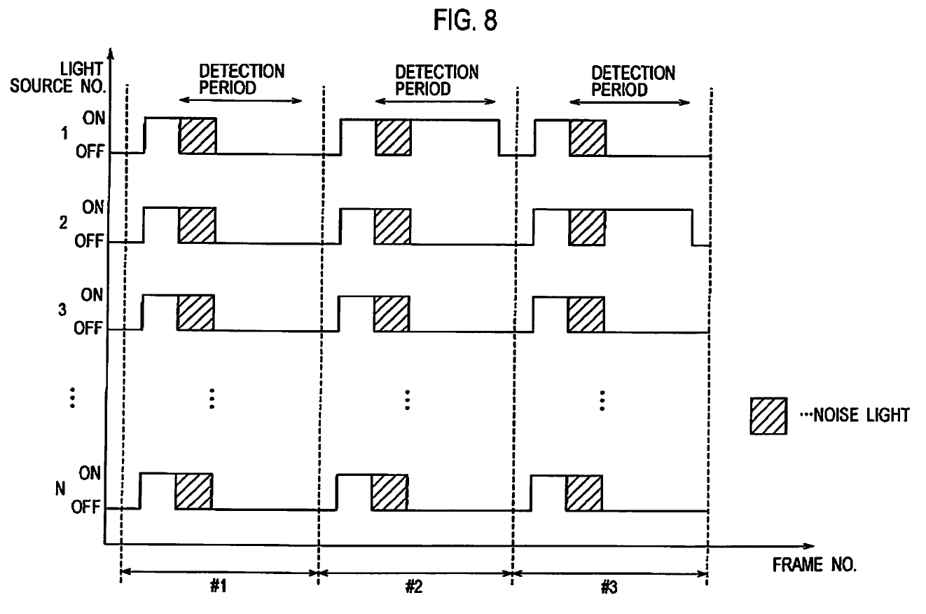

For example, as shown in FIG. 8, in the frame #1, the light amount sensor 70 detects an amount of light (hereinafter, referred to as an amount of noise light) being a noise when detecting an amount of light emitted from a measurement target light source.

In the frame #2, during a period (a light emission period) for which the solid state light source 11 of the light source No. 1 (that is, the measurement target light source) emits light, the solid state light sources 11 of the light sources No. 2 to No. N emit no light However, the solid state light source 11 of the light source No. 1 emits light over one frame section.

Here, in the frame #1, the amount of noise light has already been detected. Accordingly, a difference between an amount of light measured in the frame #2 and the amount of light measured in the frame #1 corresponds to an amount of light emitted from the solid state light source 11 of the light source No. 1.

As described above, with the use of a difference between the amount of light detected by the light amount sensor 70 and the amount of noise light, only an amount of light emitted from the measurement target light source is acquirable.

### (Light Source Control Example 6)

In a light source control example 6, as in the light source control example 1, a period in which only a measurement target light source corresponding to any one of the plurality of solid state light sources 11 emits light is provided in one frame section.

However, in the light source control example 6, the light source controlling unit 240 outputs (power control), to each one of the plurality of solid state light sources 11 at predetermined intervals (control periods), a control signal controlling an amount of light emitted from the plurality of solid state light source 11. Incidentally, the control period is preferably small enough compared with one frame section. In addition, it should be noted that the amount of light controlled by the control signal has no concept in a time axis direction and is an output (power) of each one of the solid state light sources.

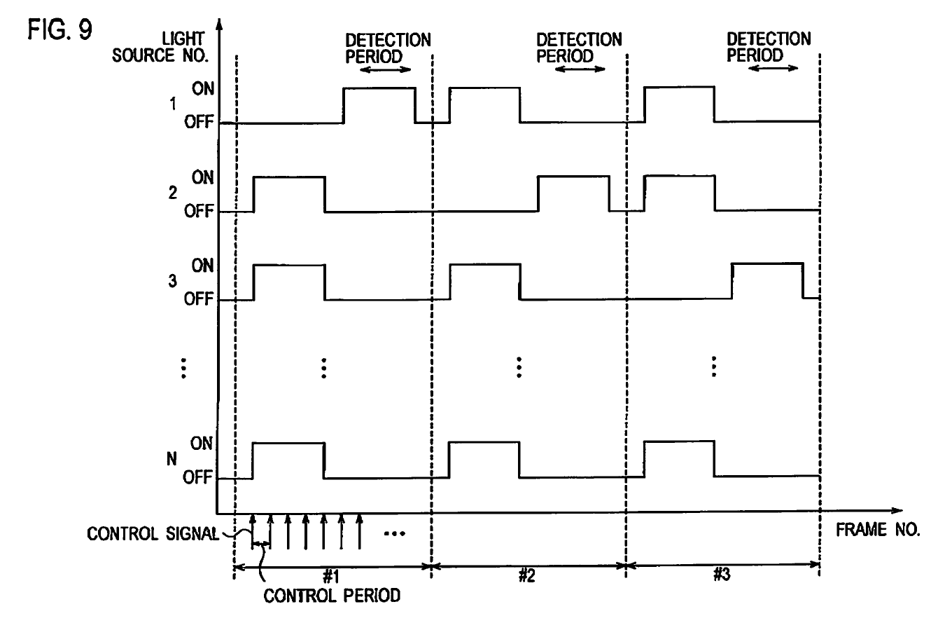

For example, as shown in FIG. 9, in the frame #1, during a period (a light emission period) for which the solid state light source 11 (i.e., a measurement target light source) of the light source No. 1 emits light, a control signal (ON signal) instructing a light emission is outputted to the solid state light source 11 of the light source No. 1. Meanwhile, during this period, a control signal (OFF signal) instructing a non-light emission is outputted to each one of the solid state light sources 11 of the light sources No. 2 to No. N.

In the power control shown in the light source control example 6, since the output (power) of each one of the solid state light sources is controlled, even when a detection period of the light amount sensor 70 is long and a required amount of light is large as shown in the light source control example 5. a total amount of light emitted from the plurality of solid state light sources 11 can be maintained without causing a light emission period of a measurement target light source and light emission period of the other solid state light source 11 to overlap each other.

### (Light Source Control Example 7)

In the above-described light source control examples 1 to 6, the light source controlling unit 240 controls a ratio (duty) in one frame section (a predetermined period) and detects an amount of light of a measurement target light source corresponding to any one of the plurality of solid state light sources 11. Accordingly, when the amount of light of a solid state light source depends greatly on temperature, i.e., control temperature, of the solid state light source, a precise light amount detection is difficult

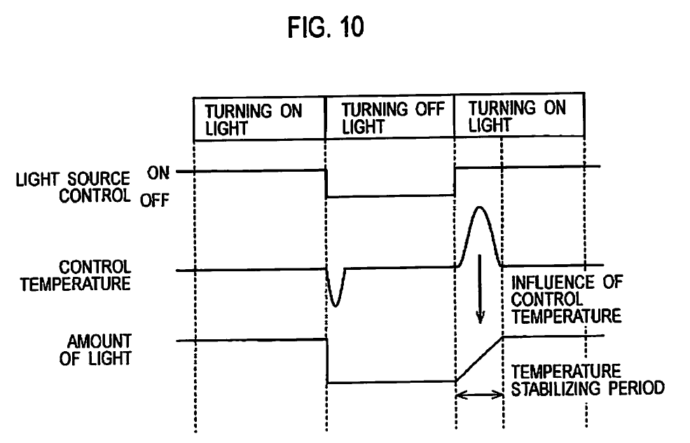

FIG. 10 is a view showing a change in an amount of light of a solid state light source 11a with respect to control temperature. The solid state light source 11a largely changes an amount of light depending on temperature. Since the amount of light of the solid state light source 11a greatly depends on control temperature, the solid state light source 11a is cooled down with a cooling means so that the control temperature is maintained at a predetermined level.

A time constant of the cooling means is extremely large in general. Accordingly, as shown in FIG. 10, when the control temperature changes for a switch of the solid state light source 11a between a light emission period and a non-light emission period, the control temperature takes a while until being restored to its original level.

Specifically, at the time of switching from the light emission period to the non-light emission period, the amount of light of the solid state light source 11a instantaneously changes. Meanwhile, since heat is no loner generated from the solid state light source 11a, the control temperature is reduced and, thereafter, restored to the original level. At the time of switching from the non-light emission period to the light emission period, power is supplied to the solid state light source 11a so that the control temperature increases. The solid state light source 11a having high dependency on temperature is incapable of emitting enough amount of light when the control temperature is high. The cooling means takes a while until being cooled down the control temperature to its original level. Therefore, during a temperature stabilizing period at the time of switching from the non-light emission period to the light emission period, a precise detection of the amount of light becomes difficult, since the amount of light is not stable.

Therefore, in the light source control example 7, the plurality of solid state light sources 11a having high dependency on temperature are assumed to be used, and an amount of light of a measurement target light source corresponding to any one of the plurality of solid state light sources 11a is measured using a change of the amount of light at the time when the measurement target light source is set to a non-emission state. In other words, timing is provided, at which only a measurement target light source corresponding to any one of the plurality of solid state light sources la is set to a non-emission state.

In addition, in the light source control example 7, when a bright image (white 100% image) is displayed, a case is assumed where not all the plurality of solid state light sources 11a need to emit light. By considering the temperature stabilizing period of the solid state light sources 11a, the light source controlling unit 240 does not change all the solid state light sources 11a to a non-emission state during a blank period as in the light source control examples 1 to 6.

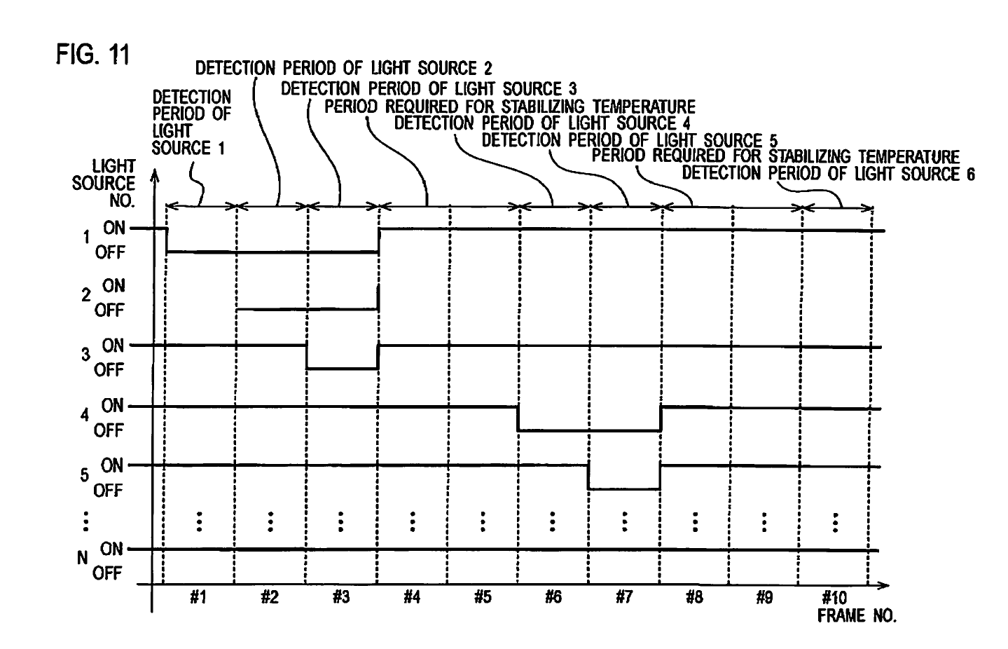

FIG. 11 shows a controlling method according to the light source control example 7. In the frame #1, the solid state light source 11a (i.e., a measurement target light source) of the light source No. 1 is measured. During this period (non-light emission period) for which the light source No. 1 emit no light, the solid state light sources 11a of the light sources No. 2 to No. N emit light. However, in a frame immediately before the frame #1, the solid state light sources 11a of the light sources No. 1 to No. N emit light.

Similarly, in the frame #2, the solid state light source 11a (i.e., a measurement target light source) of the light source No. 2 is measured. During this period (non-light emission period) for which the light sources No. 1 and No. 2 emit no light, the solid state light sources 11a of the light sources No. 3 to No. N emit light, and the measurement target light source can be consecutively measured.

In the light source control example 7, measurement (consecutive measurement up to the frame #3) is made up to the light source No. 3. This is because a difference between an amount of light when all the plurality of solid state light sources 11a emit light and an amount of light required for a bright image (white 100% image) is set as a amount of spare light. and the amount of spare light is set so that the following equations are satisfied.

Amount of Spare Light≧Amount of Light of Light Source No. 1+Amount of Light of Light Source No. 2+Amount of Light of Light Source No. 3; and

Amount of Spare Light<Amount of Light of Light Source No. 1+Amount of Light of Light Source No. 2+Amount of Light of Light Source No. 3+Amount of Light of Light Source No. 4.

After the light source No. 3 is measured in the frame #3, in order to cause the light sources No. 1 to No. 3 to stably emit light, the frames #4 and #5 are set as temperature stabilizing periods. In other words, in the frames #4 and #5, no measurement is made on a measurement target light source. In the frame #6, a measurement is made on the next light source No. 4.

In the light source control example 7, the light source controlling unit 240 sets a measurement target light source to a non-emission state, so that an amount of light of the measurement target light source is measured by using a difference in an amount of light at the time of a non-emission state. Accordingly, even for the solid state light source 11a having high dependency on temperature, consecutive measurements can be made on plurality of measurement target light sources. Therefore time required for measuring amounts of light of all the light sources can be reduced.

### (Modification 1)

In Modification 1, as in the light source control example 7, timing at which only a measurement target light source corresponding to any one of the plurality of solid state light sources 11a is set to a non-emission state is provided. The light source controlling unit 240 controls a ratio (duty) in one frame section (a predetermined period).

However. In the modification 1, when a bright image (white 100% image) is displayed, assumption is made on a case where all the plurality of solid state light sources 11a must emit light.

In the light source control example 7, a measurement of the amount of light is made when the amount of spare light is not less than a resultant amount of light after the reduction by the measurement target light source. In Modification 1, a difference between an amount of light when all the plurality of solid state light sources 11a emit light, and an amount of light being calculated, by the light source controlling unit 240, as being required for one frame section is set as an image amount of spare light. The amount of light of the measurement target light source is measured when the image amount of spare light is not less than a resultant amount of light after the reduction by the measurement target light source.

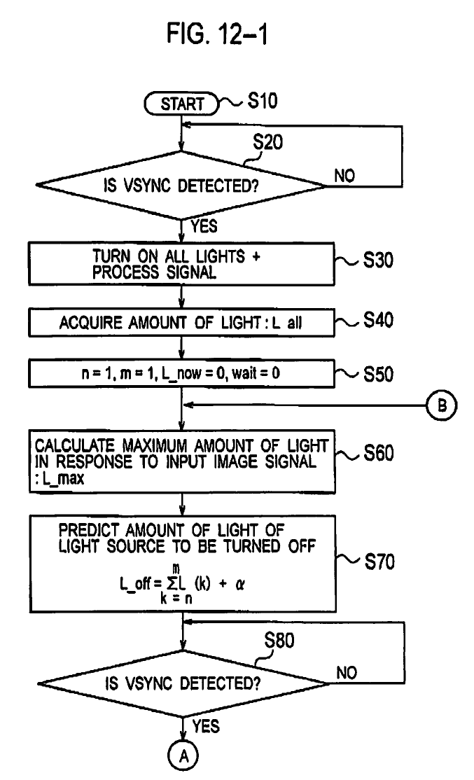

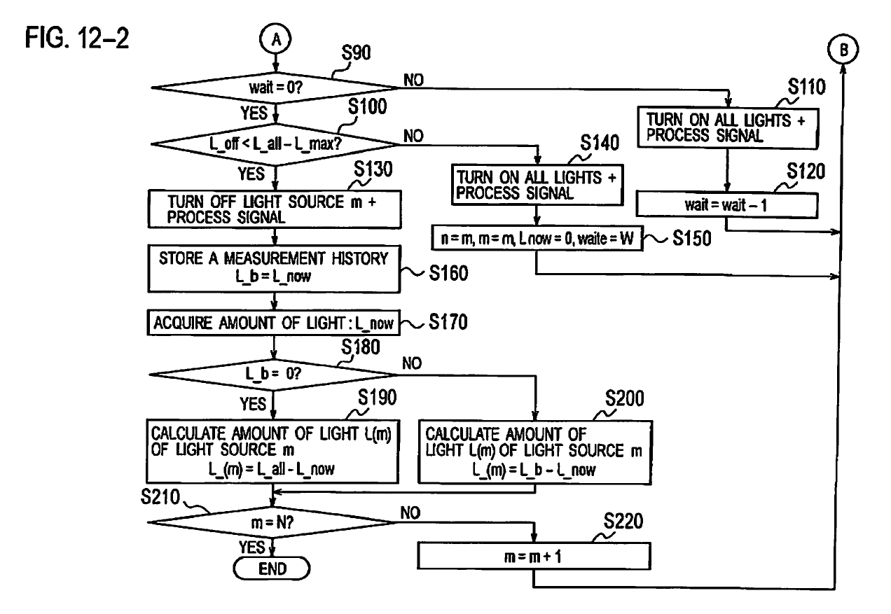

A specific controlling method of Modification 1 is described with reference to the flowcharts in FIGS. 12-1 and 12-2.

Firstly, in Step 20, a vertical synchronizing signal (hereinafter, referred to as VSYNC) indicating the switching of an image control frame is detected so that amounts of light of the plurality of solid state light sources 11a are controlled synchronously. When the VSYNC is not detected, a retry is made (NO in Step 20).

When the VSYNC is successfully detected (YES in Step 20), in Step 30, the light source controlling unit 240 causes all the solid state light sources 11a to emit light so as to acquire all the amounts of light L_all at the time of the emission of all the lights in step S30, i.e., at the time when all the solid state light sources 11 emit light. At the same time, the modulation amount controlling unit 220 controls the light imagers 30 so that a user recognize no change in an amount of light on a screen.

In Step 40, the light amount sensor 70 detects the all amounts of light L_all.

In Step 50, the following variables are respectively initialized: a variable n(=1) representing a light source No. to be firstly measured among the plurality of solid state light sources 11a which are consecutively measured; a variable m(=1) representing a light source No. of a measurement target light source: a variable L_now(=0) representing an amount of light when a light source No. m is set to a non-light emission; and a variable wait (=0) representing a temperature stabilizing period with the number of frames.

In Step 60, on the basis of an image input signal corresponding to one frame section, the light source controlling unit 240 calculates a required amount of light L_max for one frame section.

In Step 70, a predicted amount of light to be reduced L_off which is reduced from the total amount of light when the plurality of solid state light sources 11a are set to non-emission states is predicted.

For example, when the solid state light source 11a of the light source No. 1 is set as a measurement target light source, an amount of reduced light L(1) due to the switch of the light source No. 1 into a non-emission state is predicted by using measurements made up to the last time. In addition, when considering a measurement error of the light amount sensor and a reduced amount of light α due to the degradation of light sources or the like, an amount of reduced light L_off(1) which is predicted to be reduced from the total amount of light when the light source No. 1 is set to a non-emission state is expressed in the following equation.

[Equation 1]

L_off(1)=L(1)+α (1)

In accordance with Equation (1), a amount of light L_off which is predicted to be reduced from the total amount of light when, among the solid state light sources 11a, the light sources No. n to No. m are set to non-emission states is expressed in the following equation.

$$\begin{matrix}[ Equation 2 ] & \\ L\_off = {\sum }_{k = n}^{m} L ( k ) + a & ( 2 )\end{matrix}$$

In Step 80 subsequent to Step 70, a VSYNC is again detected so that controls of amounts of light in Steps 110, 130, and 140 to be described later is to be synchronized. When no VSYNC is detected, a retry is made (NO in Step 80).

After the VSYNC is detected in Step 80, if the solid state light sources 11a in non-emission state is in a temperature stabilizing period (NO in Step 90), a measurement target light source is not precisely detected. Accordingly, in Step 110, all the plurality of solid state light sources 11a are caused to emit light, and the same processing as that of Step 30 is performed.

In Step 120, the variable wait representing a temperature stabilizing period with the number of frames is decremented by 1, and then the processing returns to Step 60,

In Step 80, after the VSYNC is detected, when a temperature stabilizing period for the solid state light sources 11a in non-emission state (NO in Step 90) has elapsed (YES in Step 90), the processing moves to Step 90.

In Step 100, comparison is made between the predicted amount of light to be reduced L_off and a difference (L_all−L_max) between the all amounts of light L_all and the required amount of light L_max calculated using an image input signal, that is, an allowable amount of light which is allowed to be reduced in one frame section. When the predicted amount of light to be reduced is larger than the allowable amount of light (NO in Step 100), the processing moves to Step 140.

When the predicted amount of light to be reduced is larger than the allowable amount of light (NO in Step 100), a measurement target light source can not be measured. Accordingly, in Step 140, all the solid state light sources 11a are caused to emit light, and the same processing as that of Step 30 is performed.

In Step 150, for the preparation of the measurement on the following measurement target light source, substitutions are made to the variables n(=m), m(=m), L_now(=0), and wait(=W), and the processing returns to Step 60.

When the predicted amount of light to be reduced is smaller than the allowable amount of light (YES in Step 100), in Step 130, the light source controlling unit 240 sets the light source No. m to a non-emission state, and the modulation amount controlling unit 220 controls the light imagers 30.

In Step 160, the degradation rate calculating unit 250 stores therein the variable L_now as a history amount of light L_b.

In Step 170, the light amount sensor 70 detects a present amount of light L_now of the array light source 10 with the light source No. m being in a non-emission state. However, the present amount of light L_now detected by the light amount sensor 70, reflects a control by the modulation amount controlling unit 220 so that the user can not recognize a change of an amount of light on the screen. Therefore, it should be noted that the present amount of light L_now is corrected considering the control of the modulation amount controlling unit 220.

In Step 180, determination is made as to whether or not a certain No. of light source among the plurality of solid state light sources 11a to be consecutively measured is a first measurement target light source. In other words, determination is made as to whether or not L_b=0 holds. When the certain No. of light source is the first measurement target light source (YES in Step 180), the processing moves to Step 190. When the certain No. of light source is a second measurement target light source or the one subsequent thereto (NO in Step 180), the processing moves to Step 200.

When the certain No. of light source is the first measurement target light source (YES in Step 180), in Step 190, the degradation rate calculating unit 250 calculates a difference between the all amounts of light L_all and the present amount of light L_now, and stores therein the difference as an amount of light L(m) of the light source No. m.

When the certain No. of light source is the second measurement target light source or one subsequent thereto (NO in Step 180), in Step 200, the degradation rate calculating unit 250 calculates a difference between the history amount of light L_b and the present amount of light L_now, and stores therein the difference as an amount of light L (m) of the light source No. m.

After Step 190 or Step 200, in Step 210, determination is made as to whether or not all the solid state light sources 11a have been measured. In other words, determination is made as to whether m=N holds. When all the plurality of solid state light sources 11a have been measured (YES in Step 210), a control in the measurement of the amount of light is terminated. When not all the plurality of solid state light sources 11a have been measured (NO in Step 210), the processing moves to Step 220.

In Step 220, in order to measure the next measurement target light source, the variable m is incremented by 1 and the processing returns to Step 60.

In this way, an amount of light of a measurement target light source is measured when an image amount of spare light is not greater than an allowable amount of light so that a period of time required for the measurement of the plurality of solid state light sources 11a can be reduced. More specifically, this is effective when an amount of light corresponding to the amount of spare light in the light source control example 7 is not acquired even if all the plurality of solid state light sources 11 emit light. In addition, even when an amount of light corresponding to the amount of spare light is acquired, it is possible to make consecutive measurements on an even larger number of light sources in response to image input signals.

In addition, in Modification 1, the allowable amount of light (L_all−L_max) and the predicted amount of light to be reduced L_off are compared before a measurement of the next light source is started. However, when a change of an amount of light is large as in the case of a scene change or the like, a measurement of the amount of light may be forcibly discontinued, and a step of usual control on light sources may be added.

In Modification 1, measurements of amounts of light are made in numerical order of light sources determined in advance. However the light sources may be sorted on the basis of light emission efficiencies of measured solid state light sources 11a and the amount of light may be measured in that order.

In Modification 1, while not particularly mentioned on the reduced amount of light α, it may be a fixed value or may be a value determined by the following equation.

α=Gain×Sum of amounts of light of light sources to be set in non-emission state,

where 0<Gain<1.

In Modification 1, the description is made on the assumption that the light amount sensor 70 is provided to the projection lens unit 90. However, the light amount sensor 70 is not limited to be provided thereto, and may be provided between each one of the array light sources 10 and each one of the light imagers 30. In this case, there is no need to correct L_now to be acquired in Step 170, and a direct measurement of a measurement target light source becomes possible.

### (Modification 2)

In Modification 2, a temperature sensor 71 is provided to measure the array light sources 10, and a detection result by the light amount sensor 70 is corrected on the basis of a measurement result by the temperature sensor 71.

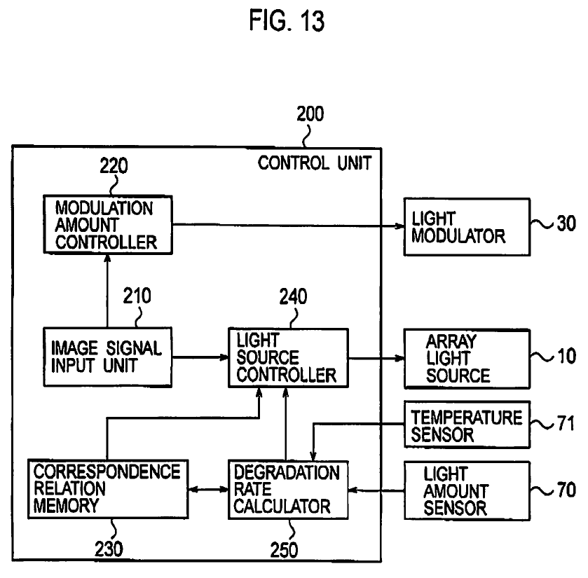

FIG. 13 is a block diagram showing a configuration of Modification 2. Provided is a temperature sensor 71 for measuring the temperature of the array light sources 10 which transfers the measurement result to the degradation rate calculating unit 250.

The degradation rate calculating unit 250 makes a temperature correction to the measurement result by the light amount sensor 70 on the basis of data from the temperature sensor 71.

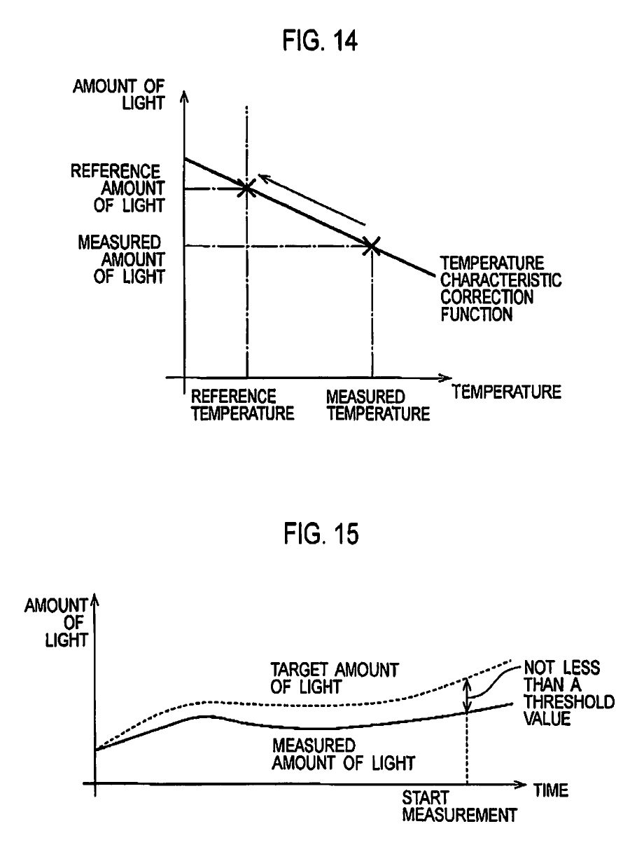

A specific temperature correction method is described with reference to FIG. 14. Firstly, the temperature sensor 71 previously acquires temperature characteristics (power versus temperature dependency of an amount of light) on all the plurality of solid state light sources 11a, and stores the characteristics as a temperature characteristic correction function. Using this function, an amount of light when the solid state light sources 11a is in a temperature of normal operation (reference temperature) can be calculated using a measured amount of light when the solid state light sources 11a is in a specific temperature (measured temperature), as shown in FIG. 14.

In this way, when the solid state light sources 11a is in the measured temperature, obtained is an amount of light (a correction amount of light) when the solid state light sources 11a is in the reference temperature which is calculated in the correction processing using the temperature characteristics correction function, on the basis of a measured amount of light of the measurement target light source. Then, a difference between the correction amount of light and a reference amount of light represents a degradation amount of light of the measurement target light source.

Thus, a temperature stabilizing period provided for stabilizing temperature is no longer required before the measurement of an amount of light, so that time required for the measurement of all the plurality of solid state light sources 11a can be reduced.

In FIG. 14, the amount of light emitted from the plurality of solid state light sources 11a changes linearly in accordance with the temperature. However, the amount of light emitted therefrom may change non-linearly. Alternatively, instead of using the temperature characteristic correction function, a temperature characteristic correction table may be stored.

### (Modification 3)

In the light source control example 7, it is assumed that the plurality of solid state light sources 11a are measured while projecting images. However, in Modification 3, it is assumed that the plurality of solid state light sources 11a are measured at the time of starting and termination of the projection display apparatus 100 or using a measurement instruction signal made at the time of starting or termination of the projection display apparatus 100.

Since the amounts of light outputted from the plurality of solid state light sources 11a is not stable at the time of starting, the output of the amounts of light is measured, and a measurement of a measurement target light source is started in response to a measurement instruction signal to be given after the output of the amounts becomes stable.

Thus, since a measurement of the amount of light is made before or after of the projection type video display device 100 projects an image, a single measurement target light source is not necessarily to be measured in one frame section, so that a expensive light amount sensor is no longer required, the sensor capable of measuring an amount of light with high accuracy in a short time. This achieves reduction in cost. Additionally, an unnecessary interruption processing is no longer to be performed while images are being projected since an amount of light can be measured at a fixed timing such as at the starting or termination.

Incidentally, in Modification 3, an amount of light is measured at the timing of starting and termination of the image projection of the projection display apparatus 100, or in response to a measurement instruction signal given at the timing of the starting or termination. However, the timing is not limited thereto. Alternatively, for example, a measurement button may be provided for allowing a user to designate the timing of light amount measurement, so that an amount of light may be measured in response to a measurement instruction signal to be given at the time when the measurement button is pressed.

### (Modification 4)

In Modification 4, a degradation amount of a total amount of light of the plurality of solid state light sources 11a is used as an index of timing at which amounts of light of the plurality of solid state light sources 11a are measured. Specifically, when the degradation amount exceeds a certain threshold, the amount of light of the plurality of solid state light sources 11a are measured.

FIG. 15 is a view showing a change of a total amount of light of the plurality of solid state light sources 11a, with respect to change in time according to Modification 4. When the plurality of solid state light sources 11a start emitting light and a projection image changes, an amount of light required for a frame image also changes in accordance with the image change. The required amount of light is represented by a fluctuation of target amount of light in dashed line of FIG. 15. In addition, when it is assumed that total amount of light of the plurality of solid state light sources 11a are not degraded with time, the target amount of light and an actual measured amount of light approximately coincide with each other. However, in practice, the total amount of light of the plurality of solid state light sources 11a is gradually degraded with time. Therefore a difference is generated between the target amount of light and the measured amount of light shown in solid line in FIG. 15.

When the difference between the target amount of light and the measured amount of light becomes no less than a certain threshold value, it is considered that any one of the plurality of solid state light sources 11a is degraded. Therefore measurement of the plurality of solid state light sources 11a is started.

In addition, measurement intervals at which total amount of light of the plurality of solid state light sources 11a are measured may be quite large compared with one frame section. The Interval is determined depending on the rate of time degradation of a solid state light source in use, but may be set to one hour, for example, for a solid state light source which is degraded at a slow rate.

Thus, amounts of light of the plurality of solid state light sources 11a are measured when a degradation amount of the total amount of light of the plurality of solid state light sources 11a exceeds a certain threshold value, whereby the measurement is made at the time when the degradation of amount of light is no longer acceptable. Accordingly, unnecessary measurement can be avoided and a power consumption is effectively reduced.

Incidentally, in Modification 4, the amounts of light of the plurality of solid state light sources 11a are measured when the difference between the target amount of light and the measured amount of light becomes no less than a certain threshold value, but the measurement condition is not limited thereto. For example, a difference between target power consumption and measured power consumption may be set as an index. Accordingly, power consumption efficiency can be prevented from being deteriorated at more than an acceptable level.

In the above-described light source control examples 1 to 6, the light source controlling unit 240 controls the emission period of each of the solid state light sources 11, so that a total amount of light emitted from the plurality of solid state light sources 11a satisfies a required amount of light but the control condition is not limited thereto.

For example, the light source controlling unit 240 may control power supplied to the respective solid state light sources 11 so that a total amount of light emitted from the plurality of solid state light sources 11a satisfies a required amount of light. The light source controlling unit 240 controls power supplied to the respective solid state light sources 11 on the basis of a correspondence relation stored in the correspondence relation memory unit 230.

For example, when the total amount of light is smaller than the required amount of light, the light source controlling unit 240 increases supplied power to one of plurality of solid state light sources 11 which has the highest emission efficiency in priority. In addition, it should be noted that a solid state light source 11 having been supplied with power at the limit (maximum rated value), is eliminated from the target for the solid state light sources 11 to which power supply is increased, even if the solid state light source has a high light emission efficiency. Meanwhile, when the total amount of light is larger than the required amount of light the light source controlling unit 240 reduces supplied power to one of plurality of solid state light sources 11 which has the lowest emission efficiency in priority.

The degradation rate calculating unit 250 acquires an amount of light from a measurement target light source being any one of the plurality of solid state light sources 11 from amounts of light detected by the light amount sensor 70. To be more specific, the degradation rate calculating unit 250 is capable of acquiring only an amount of light from a measurement target light source by use of the light source control examples 1 to 6.

Subsequently, the degradation rate calculating unit 250 acquires an amount of light (hereinafter, referred to as an acquired amount of light) of a measurement target light source, the amount of light of which is acquired from amounts of light detected by the light amount sensor 70. The degradation rate calculating unit 250 calculates a degradation rate of the measurement target light source on the basis of the acquired light amount.

More specifically, the degradation rate calculating unit 250 acquires an amount of light (a reference amount of light) corresponding to power which is currently being supplied to a measurement target light source with reference to correspondence relation for measurement target light source stored in the correspondence relation memory unit 230. Subsequently, the degradation rate calculating unit 250 calculates a degradation rate (acquired amount of light/reference amount of light) of the measurement target light source by comparing the acquired amount of light and the reference amount of light.

The degradation rate calculating unit 250 updates a curve L representing the correspondence relation of the measurement target light source stored in the correspondence relation memory unit 230, depending on the degradation rate of the measurement target light source. More specifically, the degradation rate calculating unit 260 updates the curve L, downward, representing the correspondence relation of the measurement target light source, when the measurement target light source is degraded. In other words, the degradation rate calculating unit 250 updates the curve L representing the correspondence relation of the measurement target light source to show light emission efficiency of the measurement target light source is reduced.

### (Operation of the Projection Display Apparatus)

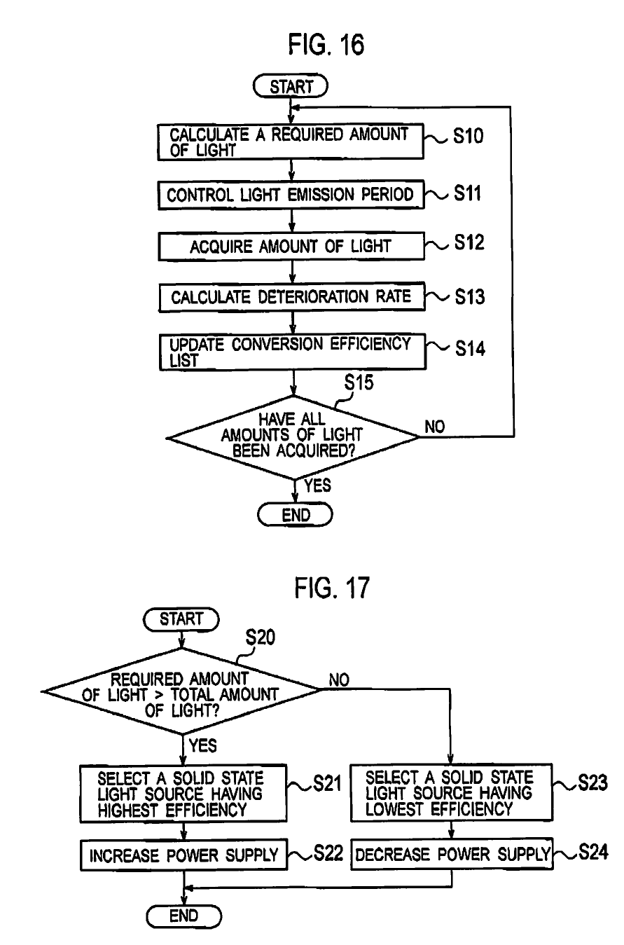

Operation of the projection display apparatus according to the first embodiment is described below with reference to drawings. FIGS. 16 and 17 are flowcharts showing operation of the projection display apparatus 100 according to the first embodiment.

Firstly, operation of the projection display apparatus 100 for acquiring an amount of light of a measurement target light source is described with reference to FIG. 16.

As shown in FIG. 16, in Step 10, the projection display apparatus 100 calculates a required amount of light required in a frame #n, on the basis of a image input signal corresponding to the frame #n.

In Step 11, the projection display apparatus 100 controls a period (a light emission period) for which the plurality of solid state light sources 11 emit light, so that a total amount of light emitted from the plurality of solid state light sources 11 satisfies the required amount of light. In addition, as described above, the light emission period may be controlled by a ratio (duty) control or a power control.

In Step 12, the projection display apparatus 100 detects the amount of light emitted from plurality of solid state light sources 11 using the light amount sensor 70. Subsequently, the projection display apparatus 100 acquires the amount of light emitted from measurement target light source.

In Step 13, on the basis of an amount of light of a measurement target light source acquired in Step 12, the projection display apparatus 100 calculates a degradation rate of the measurement target light source.

In Step 14, on the basis of the degradation rate of the measurement target light source, the projection display apparatus 100 updates a correspondence relation of the measurement target light source stored in the correspondence relation memory unit 230.

In Step 15, the projection display apparatus 100 determines whether or not amounts of light of all the solid state light sources 11 have been acquired. When the determination is made that amounts of light of all the solid state light sources 11 have been acquired, the projection display apparatus 100 terminates a sequence of processing. Meanwhile, when the determination is made that amounts of light of all the solid state light sources 11 have not been acquired, the projection display apparatus 100 returns to Step 10. Note that, after returning to Step 10, the projection display apparatus 100 certainly shifts its operation to a control of a light emission period in a frame #n+1 and switches the measurement target light source.

Next, operation of the projection display apparatus 100 for controlling power supplied to a solid state light source 11 is described with reference to FIG. 17. In addition, processing shown in FIG. 17 may be performed instead of the processing (control of the light emission period) of Step 11 described above, or may be performed along with the processing (control of the light emission period).

As shown in FIG. 17, in Step 20, the projection display apparatus 100 determines whether the total amount of light emitted from the plurality of solid state light sources 11 is smaller than the required amount of light for the frame #n. The projection display apparatus 100 shifts its operation to a processing of Step 2l when the total amount of light is smaller than the required amount of light. Meanwhile, the projection display apparatus 100 shifts its operation to a processing of Step 23 when the total amount of light is not less than the required amount of light.

In Step 21, the projection display apparatus 100 selects a solid state light source 11 having the highest light emission efficiency with reference to the correspondence relation memory unit 230. In Step 21, as shown in FIG. 3, power presently being supplied to each one of the solid state light sources 11 is considered, in Step 22, the projection display apparatus 100 increases power supplied to the solid state light source 11 selected in Step 21 so that the total amount of light is increased up to the required amount of light.

In Step 23, the projection display apparatus 100 selects a solid state light source 11 having the lowest light emission efficiency with reference to the correspondence relation memory unit 230. In Step 23, as shown in FIG. 3, power presently being supplied to each one of the solid state light sources 11 is considered.

In Step 24, the projection display apparatus 100 reduces power supplied to the solid state light source 11 selected in Step 23 so that the total amount of light is reduced down to the required amount of light.

### (Operation and Advantage)

In the first embodiment, the light source controlling unit 240 controls, for each of the plurality of state light sources 11, emission periods in which the plurality of solid state light sources 11 emit light, so that the degradation rate calculating unit 250 acquires the amount of light emitted from the measurement target light source. Accordingly, even when the plurality of solid state light sources 11 are arranged in array, the amount of light emitted from each of the plurality of state light source 11 is detectable.

In the first embodiment, when increasing a total amount of light emitted from the plurality of solid state light sources 11, the light source controlling unit 240 preferentially increases power supplied to a solid state light source 11 having high light emission efficiency with reference to the correspondence relation memory unit 230. In the meantime, when reducing a total amount of light emitted from the plurality of solid state light sources 11, the light source controlling unit 240 preferentially reduces power supplied to a solid state light source 11 having low light emission efficiency with reference to the correspondence relation memory unit 230.

Therefore, the total amount of light emitted from the plurality of solid state light sources 11 can be controlled while preventing unnecessary power consumption of the plurality of solid state light sources 11.

### Second Embodiment

A second embodiment of the present invention is described below with reference to drawings. Different points between the second embodiment and the first embodiment are chiefly described below.

To be more specific, in the first embodiment, the light amount sensor 70 is provided to the projection lens unit 90. Meanwhile, in the second embodiment, the light amount sensor 70 is provided to the cross dichroic prism 50.

### (Configuration of a Projection Display Apparatus)

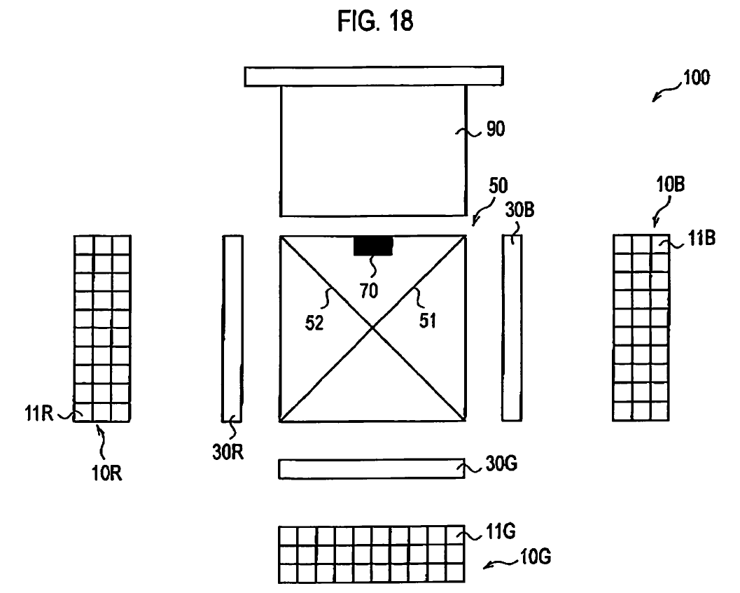

A configuration of a projection display apparatus according to the second embodiment is described below with reference to drawings. FIG. 18 is a schematic view showing a configuration of a projection display apparatus 100 according to the second embodiment. It should be noted that in FIG. 18, those parts which are the same as those in FIG. 1 are given the same reference numerals.

As shown in FIG. 18, the light amount sensor 70 is provided to the cross dichroio prism 50. Incidentally, as in the first embodiment, the light amount sensor 70 is preferably provided outside an effective use range of the synthetic light combined by the cross dichroic prism 50.

### Other Embodiment

The present invention has been set forth in the above-described embodiments. But it should not be understood that the discussion and the drawings constituting a part of this disclosure limit the present invention. It is apparent to those skilled in the art that various alternatives, modifications, and the practices can be achieved from this disclosure.

In the above-described embodiments, when increasing the total amount of light emitted from the plurality of solid state light sources 11, the projection display apparatus 100 selects a solid state light source 11 having the highest light emission efficiency with reference to the correspondence relation memory unit 230, but the selection is not limited thereto. More specifically, the projection display apparatus 100 may select the plurality of solid state light sources 11 in the descending order of light emission efficiencies. In addition, the projection display apparatus 100 preferably selects a solid state light source 11 which increases more power, so that the total power consumption of the plurality of solid state light sources 11 is reduced.

Similarly, when reducing the total amount of light emitted from the plurality of solid state light sources 11, the projection display apparatus 100 selects a solid state light source 11 having the lowest light emission efficiency with reference to the correspondence relation memory unit 230, but the selection is not limited thereto. More specifically, the projection display apparatus 100 may select the plurality of solid state light sources 11 in the ascending order of light emission efficiencies. In addition, the projection display apparatus 100 preferably selects a solid state light source 11 which reduce more power, so that the total power consumption of the plurality of solid state light sources 11 is reduced.

While not particularly described in the above embodiments, a point may be considered in which an amount of light of a solid state light source 11 detected by the light amount sensor 70 is different depending on an arrangement position of the solid state light source 11.

In the above embodiments, the light amount sensor 70 detects an amount of synthetic light obtained by combining red component light, green component light and blue component light However, the detection is not limited thereto. To be more specific, the light amount sensor 70 may be configured to individually detect red component light, green component light, and blue component light. In this case, the light source controlling unit 240 may, simultaneously, control the solid state light source 11 R provided to the array light source 10R, the solid state light source 11G provided to the array light source 10G, and the solid state light source 11B provided to the array light source 10B.

In the above-described embodiments, the light amount sensor 70 is provided to the cross dichroio prism 50 or to the projection lens unit 90, but the provision is not limited thereto. More specifically, the light amount sensor 70 may be provided to an overscan portion of a screen on which an image is projected.

In the above-described embodiments, a single light amount sensor 70 is provided, but it is not necessary a single one. To be more specific, to each one of the array light sources 10 (array light sources 10R, 10G, and 10B), a single light amount sensor 70 is provided. In this case, the light amount sensor 70 is provided on a path of light emitted from each one of the array light sources 10.

While not particularly described in the above embodiments, a solid state light source 11 having the degradation rate exceeding a predetermined value may be notified to a user, so that the solid state light source 11 having the degradation rate exceeding a predetermined value may be expedited to be replaced.

While not particularly described in the above embodiments, an optical element (a fly eye lens or a tapered rod) which uniformizes light emitted from the array light source 10 is preferably provided. Using the element, light emitted from all the solid state light sources 11 constituting the array light sources 10, securely, reaches the light amount sensor 70, so that a degradation of a solid state light source 11 can be securely detected.

In the light source control examples 1 to 6, controls on a light emission period and a non-light emission period are performed on each frame section, but the control is not limited thereto. More specifically, controls on a light emission period and a non-light emission period may be performed on each group of frame sections.

While not particularly described in the above embodiments, a timing (a position in a detection period in one frame section) at which the light amount sensor 70 detects an amount of light may be changed depending on a control of an amount of light of a solid state light source 11 by the light source controlling unit 240. For example, in the case where a period in which only a measurement target light source emits light is provided on any position in one frame section by a power control, a timing at which the light amount sensor 70 detects an amount of light may aligned with a light emission period of the measurement target light source.

In the above embodiments, the light amount sensor 70 is provided on paths of light emitted from the plurality of solid state light sources 11, but the position is not limited thereto. To be more specific, the light amount sensor 70 may be provided on a position on which leaked light emitted from the plurality of solid state light sources 11 is detectable.

While not explicitly described in the above embodiments, the solid state light sources 11 are basically driven with an electric current, while not limited thereto. The solid state light sources 11 may be driven with a voltage.

What is claimed is:

1. A lighting unit including a plurality of solid state light sources, comprising:
a sensor configured to detect an amount of light emitted from the plurality of solid state light sources;
a light source controlling unit configured to control emission periods in which the plurality of solid state light source emit light for each of the plurality of solid state light sources;
an acquisition unit configured to acquire, from the amount of light detected by the sensor, an amount of light emitted from a measurement target light source which is any one of the plurality of solid state light sources, wherein
the light source controlling unit controls the emission periods so that the acquisition unit acquires the amount of light emitted from the measurement target light source.

2. The lighting unit according to claim 1 further comprising:
a calculating unit configured to calculate a required amount of light in one frame section based on an image input signal, wherein
the light source controlling unit controls the emission periods in the one frame section in accordance with the required amount of light calculated by the calculating unit.

3. The lighting unit according to claim 1, wherein
the light source controlling unit controls, in a predetermined frame section, a ratio of the emission periods and non-emission periods, the non-emission periods is periods which the plurality of solid state light sources emit no light.

4. The lighting unit according to claim 1, wherein
the light source controlling unit outputs, to each of the plurality of solid state light sources in a predetermined cycle, a control signals controlling the amount of the light emitted from the plurality of solid state light sources.

5. The lighting unit according to claim 1, wherein
the light source controlling unit controls the emission periods so that the acquisition unit consecutively acquires the amount of light emitted from the measurement target light source.

6. The lighting unit according to claim 1, further comprising a temperature sensor configured to detect temperatures of the plurality of solid state light sources, wherein
a acquired result by the acquisition unit is corrected in accordance with a detected result by the temperature sensor.

7. The lighting unit according to claim 1, wherein
the acquisition unit acquires the amount of light emitted from the measurement target light source, only when a predetermined measurement instruction signal is given.

8. The lighting unit according to claim 1, comprising:
a memory unit configured to store, for each of the plurality of solid state light sources, a correspondence relation between supplied power to each of the plurality of solid state light sources and an amount of light emitted from each of the plurality of solid state light sources, wherein
when increasing a total amount of light emitted from the plurality of solid state light sources, the light source controlling unit, preferentially, increases power supplied to a solid state light source having high light emission efficiency among the plurality of solid state light sources with reference to the memory unit.

9. The lighting unit according to claim 1, comprising:
a memory unit configured to store, for each of the plurality of solid state light sources, a correspondence relation between power supplied to each of the plurality of solid state light sources and an amount of light emitted from each of the plurality of solid state light sources, wherein
when reducing a total amount of light emitted from the plurality of solid state light sources, the light source controlling unit, preferentially, reduces supplied power to a solid state light source having low light emission efficiency among the plurality of solid state light sources with reference to the memory unit.

10. A projection display apparatus comprising
the lighting unit according to any one of claims 1 to 9, and
a projection lens unit configured to project light emitted from the lighting unit.
